(19) United States
(12) Patent Application Publication
(10) Pub. No.: US 2013/0093920 A1
(43) Pub. Date: Apr. 18, 2013

(54) ELECTRONIC CAMERA

(71) Applicant: SANYO ELECTRIC CO., LTD., Osaka (JP)

(72) Inventor: Masayoshi Okamoto, Osaka (JP)

(73) Assignee: SANYO ELECTRIC CO., LTD., Osaka (JP)

(21) Appl. No.: 13/650,181

(22) Filed: Oct. 12, 2012

(30) Foreign Application Priority Data
Oct. 17, 2011 (JP) 2011-228330

(51) Int. Cl. H04N 5/228; H04N 5/235; H04N 9/68

(52) U.S. Cl. 348/229.1; 348/222.1; 348/234; 348/E05.031; 348/E09.051; 348/E05.037

(57) ABSTRACT

An electronic camera includes a plurality of imagers. Each of the imagers outputs an image representing a common scene. A first searcher searches for a partial image satisfying a predetermined condition from the image outputted from a part of the plurality of imagers. A first adjuster adjusts an imaging condition of another part of the plurality of imagers to a condition different from an imaging condition at a time point at which a process of the first searcher is executed. A second searcher searches for the partial image satisfying the predetermined condition from an image outputted from an imager noticed by the first adjuster, in association with an adjusting process of the first adjuster. A second adjuster adjusts an imaging condition of at least a part of the plurality of imagers by noticing the partial image detected by the first searcher and/or the second searcher.

### CROSS REFERENCE OF RELATED APPLICATION

The disclosure of Japanese Patent Application No. 2011-228330, which was filed on Oct. 17, 2011, is incorporated herein by reference.

### BACKGROUND OF THE INVENTION

1. Field of the Invention

The present invention relates to an electronic camera, and in particular, relates to an electronic camera which searches for an image coincident with a specific object image from a designated image.

2. Description of the Related Art

According to one example of this type of camera, a face region is detected by a face region detecting portion from a face image captured by an imaging device. It is determined whether or not an image of the detected face region is appropriate for a recognition process, and when it is determined as being inappropriate for the recognition process, an exposure amount is decided so as to be optimal for the recognition process. That is, the exposure amount is decided so that an error between a histogram of a pixel value of a face region image and a histogram of a pixel value of a standard image becomes within predetermined.

However, in the above-described camera, an exposure amount optimal for the recognition process is decided based on the face region detected by the face region detecting portion. Thereby, an imaging condition for a face image is not appropriately adjusted when the face image is included in a region undetected by the face region detecting portion, and therefore, an imaging performance may be deteriorated.

### SUMMARY OF THE INVENTION

An electronic camera according to the present invention comprises: a plurality of imagers each of which outputs an image representing a common scene; a first searcher which searches for a partial image satisfying a predetermined condition from the image outputted from a part of the plurality of imagers; a first adjuster which adjusts an imaging condition of another part of the plurality of imagers to a condition different from an imaging condition at a time point at which a process of the first searcher is executed; a second searcher which searches for the partial image satisfying the predetermined condition from an image outputted from an imager noticed by the first adjuster, in association with an adjusting process of the first adjuster; and a second adjuster which adjusts an imaging condition of at least a part of the plurality of imagers by noticing the partial image detected by the first searcher and/or the second searcher.

According to the present invention, an imaging control program recorded on a non-transitory recording medium in order to control an electronic camera provided with a plurality of imagers each of which outputs an image representing a common scene, the program causing a processor of the electronic camera to perform the steps, comprises: a first searching step of searching for a partial image satisfying a predetermined condition from the image outputted from a part of the plurality of imagers; a first adjusting step of adjusting an imaging condition of another part of the plurality of imagers to a condition different from an imaging condition at a time point at which a process of the first searching step is executed; a second searching step of searching for the partial image satisfying the predetermined condition from an image outputted from an imager noticed by the first adjusting step, in association with an adjusting process of the first adjusting step; and a second adjusting step of adjusts an imaging condition of at least a part of the plurality of imagers by noticing the partial image detected by the first searching step and/or the second searching step.

According to the present invention, an imaging control method executed by an electronic camera provided with provided with a plurality of imagers each of which outputs an image representing a common scene, comprises: a first searching step of searching for a partial image satisfying a predetermined condition from the image outputted from a part of the plurality of imagers; a first adjusting step of adjusting an imaging condition of another part of the plurality of imagers to a condition different from an imaging condition at a time point at which a process of the first searching step is executed; a second searching step of searching for the partial image satisfying the predetermined condition from an image outputted from an imager noticed by the first adjusting step, in association with an adjusting process of the first adjusting step; and a second adjusting step of adjusts an imaging condition of at least a part of the plurality of imagers by noticing the partial image detected by the first searching step and/or the second searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one portion of an external appearance of a camera of one embodiment of the present invention;

FIG. 4 is an illustrative view showing one example of a mapping state of an SDRAM applied to the embodiment in FIG. 2;

FIG. 5 is an illustrative view showing one example of an assignment state of an evaluation area in an imaging surface;

FIG. 6 is an illustrative view showing one example of a face-detection frame structure used in a face detecting process;

FIG. 7 is an illustrative view showing one example of a configuration of a face dictionary referred to in the embodiment in FIG. 2;

FIG. 8 is an illustrative view showing one portion of the face detecting process;

FIG. 9 is an illustrative view showing one example of a configuration of a register referred to in the embodiment in FIG. 2;

FIG. 10 is an illustrative view showing one example of a configuration of another register referred to in the embodiment in FIG. 2;

FIG. 11 is an illustrative view showing one example of a configuration of a table referred to in the embodiment in FIG. 2;

FIG. 12 is an illustrative view showing one example of a configuration of another table referred to in the embodiment in FIG. 2;

FIG. 13 is an illustrative view showing one example of an image displayed on a monitor screen;

FIG. 14 is an illustrative view showing another example of the image displayed on a monitor screen;

FIG. 15 is an illustrative view showing still another example of the image displayed on a monitor screen;

FIG. 16 is an illustrative view showing yet another example of the image displayed on a monitor screen;

FIG. 17 is a flowchart showing one portion of behavior of a CPU applied to the embodiment in FIG. 2;

FIG. 18 is a flowchart showing another portion of behavior of the CPU applied to the embodiment in FIG. 2;

FIG. 19 is a flowchart showing still another portion of behavior of the CPU applied to the embodiment in FIG. 2;

FIG. 20 is a flowchart showing yet another portion of behavior of the CPU applied to the embodiment in FIG. 2;

FIG. 21 is a flowchart showing another portion of behavior of the CPU applied to the embodiment in FIG. 2;

FIG. 22 is a flowchart showing still another portion of behavior of the CPU applied to the embodiment in FIG. 2;

FIG. 23 is a flowchart showing yet another portion of behavior of the CPU applied to the embodiment in FIG. 2;

FIG. 24 is a flowchart showing another portion of behavior of the CPU applied to the embodiment in FIG. 2;

FIG. 25 is a flowchart showing still another portion of behavior of the CPU applied to the embodiment in FIG. 2;

FIG. 26 is a flowchart showing yet another portion of behavior of the CPU applied to the embodiment in FIG. 2;

FIG. 27 is a flowchart showing another portion of behavior of the CPU applied to the embodiment in FIG. 2; and

FIG. 28 is a block diagram showing a configuration of another embodiment of the present invention.

### DETAILED DESCRIPTION OF THE PREFERRED EMBODIMENTS

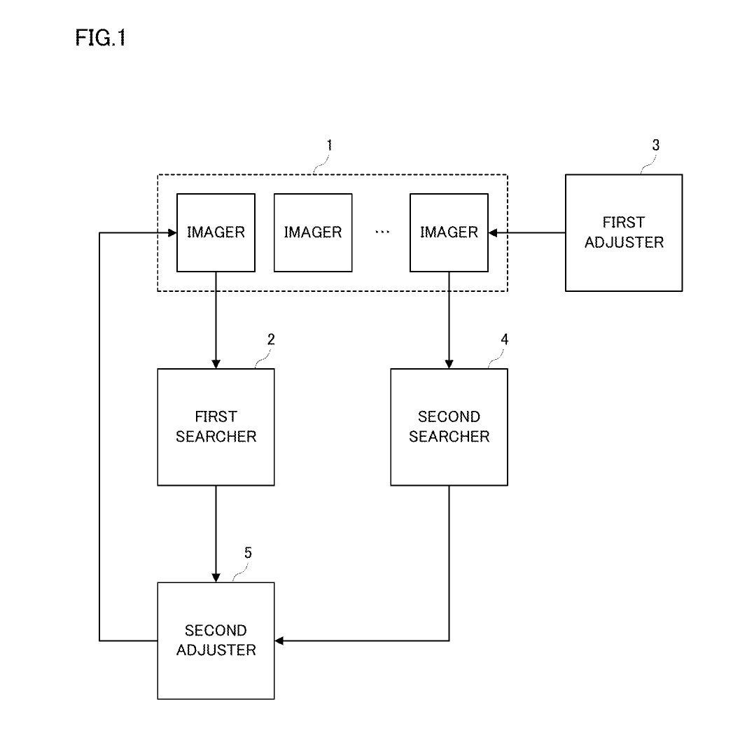

With reference to FIG. 1, an electronic camera according to one embodiment of the present invention is basically configured as follows: Each of a plurality of imagers 1 outputs an image representing a common scene. A first searcher 2 searches for a partial image satisfying a predetermined condition from the image outputted from a part of the plurality of imagers 1. A first adjuster 3 adjusts an imaging condition of another part of the plurality of imagers to a condition different from an imaging condition at a time point at which a process of the first searcher 2 is executed. A second searcher 4 searches for the partial image satisfying the predetermined condition from an image outputted from an imager noticed by the first adjuster 3, in association with an adjusting process of the first adjuster 3. A second adjuster 5 adjusts an imaging condition of at least a part of the plurality of imagers 1 by noticing the partial image detected by the first searcher 2 and/or the second searcher 4.

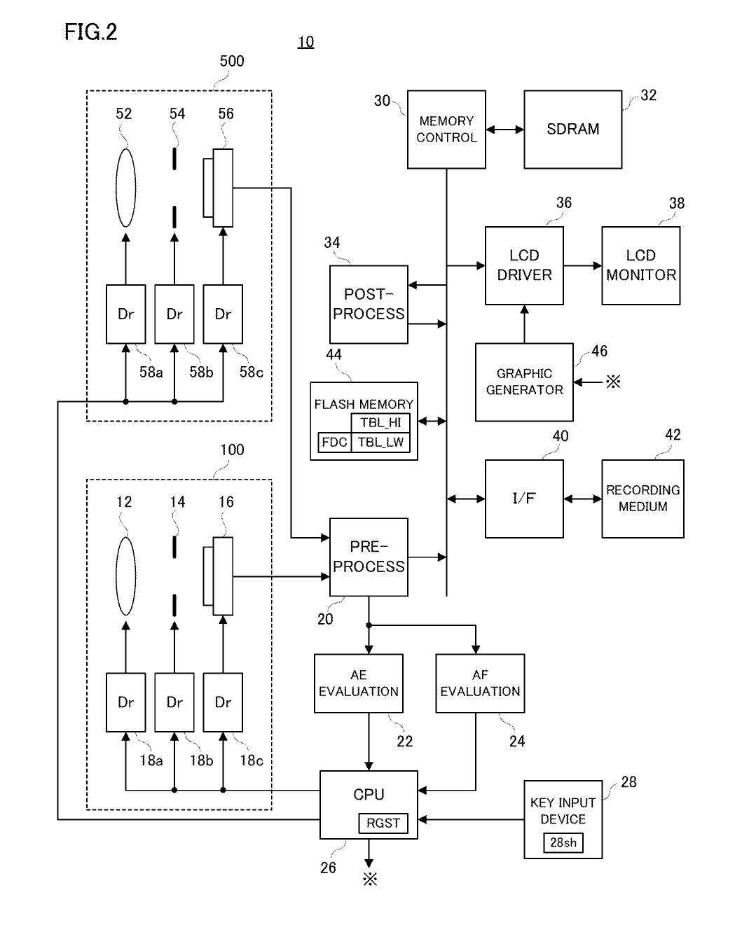

With reference to FIG. 2, a digital camera 10 according to one embodiment includes a focus lens 12 and an aperture unit 14 driven by drivers 18a and 18b, respectively. An optical image of a scene that underwent these components enters, with irradiation, an imaging surface of an image sensor 16, and is subjected to a photoelectric conversion. Moreover, the focus lens 12, the aperture unit 14, the image sensor 16, and the drivers 18a to 18c configure a first imaging block 100.

Furthermore, the digital camera 10 is provided with a focus lens 52, an aperture unit 54, and an image sensor 56 in order to capture a scene common to a scene captured by the image sensor 16. An optical image that underwent the focus lens 52 and the aperture unit 54 enters, with irradiation, an imaging surface of the image sensor 56 driven by a driver 58c, and is subject to a photoelectric conversion. Moreover, the focus lens 52, the aperture unit 54, the image sensor 56, and the drivers 58a to 58c configure a second imaging block 500.

By these members, charges corresponding to the scene captured by the image sensor 16 and charges corresponding to the scene captured by the image sensor 56 are generated.

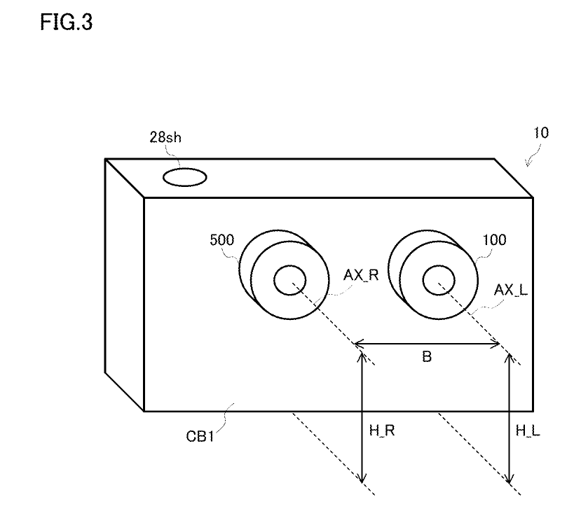

With reference to FIG. 3, the first imaging block 100 and the second imaging block 500 are fixedly provided to a front surface of a housing CB1 of the digital camera 10. The first imaging block 100 is positioned at a left side toward a front of the housing CB1 and the second imaging block 500 is positioned at a right side toward the front of the housing CB1. Hereafter, the first imaging block 100 is called a “L-side imaging block”, and the second imaging block 500 is called a “R-side imaging block”.

The L-side imaging block and the R-side imaging block have optical axes AX_L and AX_R respectively, and a distance (=H_L) from a bottom surface of the housing CB1 to the optical axis AX_L coincides with a distance (=H_R) from the bottom surface of the housing CB1 to the optical axis AX_R. Moreover, an interval (=B) between the optical axes AX_L and AX_R in a horizontal direction is set to about six centimeters in consideration of an interval between both eyes of the human. Furthermore, the L-side imaging block and the R-side imaging block have a common magnification.

The digital camera 10 has two imaging modes of a 3D recording mode for recoding a 3D (three dimensional) still image and a normal recording mode for recording a 2D (two dimensional) still image. Each of the two imaging mode is mutually switched by an operator operating a key input device 28.

When a power source is applied, in order to execute a moving image taking process, a CPU 26 commands each of the drivers 18c and 58c to repeat an exposure procedure and an electric-charge reading-out procedure under an imaging task. In response to a vertical synchronizing signal Vsync periodically generated from an SG (Signal Generator) not shown, the drivers 18c and 58c respectively expose the imaging surfaces of the image sensors 16 and 56 and read out the electric charges generated on the imaging surfaces of the image sensors 16 and 56, in a raster scanning manner. From the image sensor 16, first raw image data that is based on the read-out electric charges is cyclically outputted, and from the image sensor 56, second raw image data that is based on the read-out electric charges is cyclically outputted.

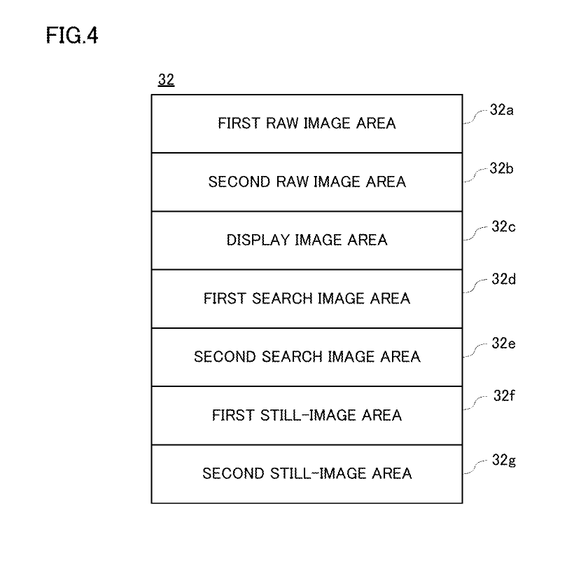

A pre-processing circuit 20 performs processes such as digital clamp, pixel defect correction, and gain control and etc., on each of the first raw image data and the second raw image data respectively outputted from the image sensors 16 and 56. The first raw image data and the second raw image data on which these processes are performed are respectively written in a first raw image area 32a and a second raw image area 32b of an SDRAM 32 shown in FIG. 4 through a memory control circuit 30.

A post-processing circuit 34 reads out the first raw image data stored in the first raw image area 32a through the memory control circuit 30, and performs a color separation process, a white balance adjusting process and a YUV converting process, on the read-out first raw image data. Furthermore, the post-processing circuit 34 executes a zoom process for display and a zoom process for search to image data that comply with a YUV format, in a parallel manner. As a result, display image data and first search image data that comply with the YUV format are individually created. The display image data is written into a display image area 32c of the SDRAM 32 shown in FIG. 4 by the memory control circuit 30. The first search image data is written into a first search image area 32d of the SDRAM 32 shown in FIG. 4 by the memory control circuit 30.

Furthermore, the postprocessing circuit 34 reads out the second raw image data stored in the second raw image area 32b through the memory control circuit 30, and performs the color separation process, the white balance adjusting process and the YUV converting process, on the read-out second raw image data. Furthermore, the postprocessing circuit 34 executes the zoom process for search to image data that comply with the YUV format. As a result, second search image data that comply with the YUV format is created. The second search image data is written into a second search image area 32e of the SDRAM 32 shown in FIG. 4 by the memory control circuit 30.

An LCD driver 36 repeatedly reads out the display image data stored in the display image area 32c through the memory control circuit 30, and drives an LCD monitor 38 based on the read-out image data. As a result, a real-time moving image (a live view image) representing the scene is displayed on a monitor screen.

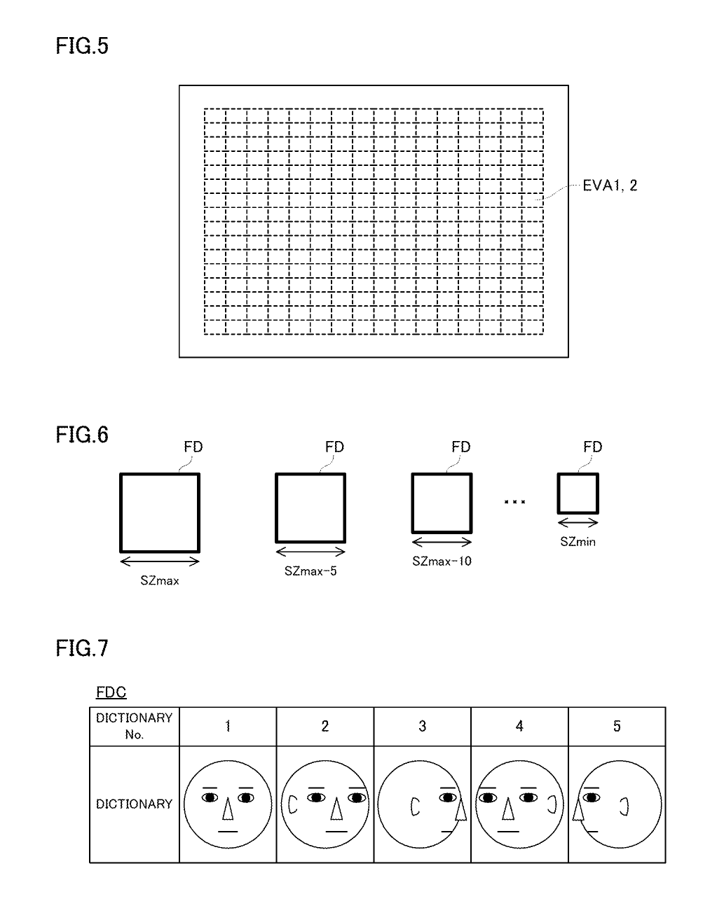

With reference to FIG. 5, evaluation areas EVA1 and EVA2 are respectively assigned to centers of the imaging surfaces of the image sensors 16 and 56. Each of the evaluation areas EVA1 and EVA2 is divided into 16 portions in each of a horizontal direction and a vertical direction; therefore, 256 divided areas form each of the evaluation areas EVA1 and EVA2. Moreover, in addition to the above-described processes, the pre-processing circuit 20 shown in FIG. 2 executes a simple RGB converting process which simply converts each of the first raw image data and the second raw image data into RGB data. As a result, each of first RGB data corresponding to the L-side imaging block and second RGB data corresponding to the R-side imaging block is outputted from the pre-processing circuit 20.

An AE evaluating circuit 22 integrates each of RGB data belonging to the evaluation area EVA1 out of the first RGB data and RGB data belonging to the evaluation area EVA2 out of the second RGB data, at every time the vertical synchronization signal Vsync is generated. Thereby, 256 integral values corresponding to the L-side imaging block and 256 integral values corresponding to the R-side imaging block (256 AE evaluation values corresponding to the L-side imaging block and 256 AE evaluation values corresponding to the R-side imaging block) are outputted from the AE evaluating circuit 22 in response to the vertical synchronization signal Vsync.

An AF evaluating circuit 24 integrates a high frequency component of the RGB data belonging to the evaluation area EVA1 out of the first RGB data generated by the pre-processing circuit 20, at every time the vertical synchronization signal Vsync is generated. Thereby, 256 integral values (256 AF evaluation values) are outputted from the AF evaluating circuit 24 in response to the vertical synchronization signal Vsync. Processes based on thus acquired AE evaluation values and the AF evaluation values will be described later.

Under a first face detecting task executed in parallel with the imaging task, the CPU 26 clears a registration content in order to initialize a first face-detection register RGSTdtL, and sets a flag FLG_L to “0” as an initial setting. Subsequently, the CPU 26 executes a face detecting process in order to search for a face image of a person from the first search image data stored in the first search image area 32d, at every time the vertical synchronization signal Vsync is generated. It is noted that, in the face detecting process executed under the first face detecting task, the whole evaluation area EVA1 is designated as a search area, and a first work register RGSTwkL is designated as a registration destination of a search result.

In the face detecting process, used are a face-detection frame structure FD of which the size is adjusted as shown in FIG. 6 and a face dictionary FDC containing five dictionary images (=face images of which the directions are mutually different) shown in FIG. 7. It is noted that the face dictionary FDC is stored in a flash memory 44. Moreover, in order to define a variable range of the size of the face-detection frame structure FD, a maximum size SZmax is set to “200”, and a minimum size SZmin is set to “20”.

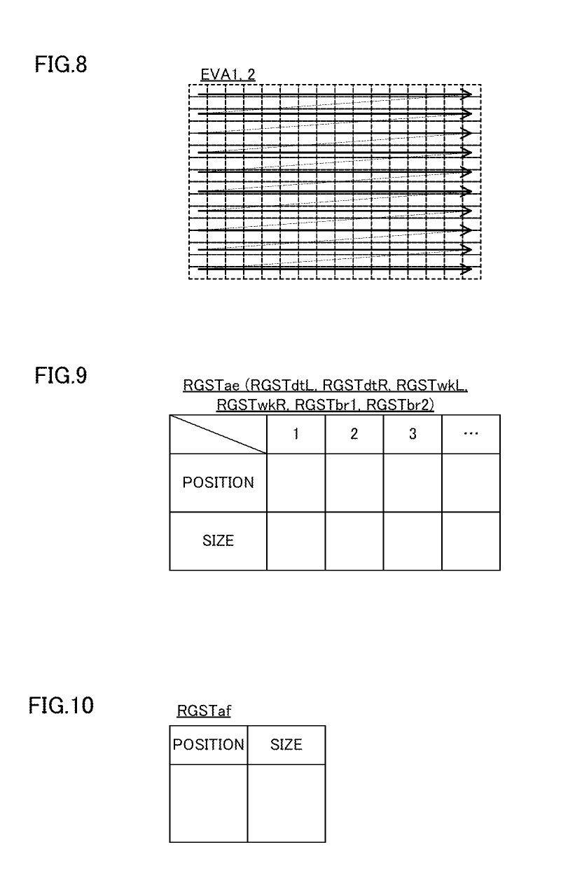

The face-detection frame structure FD is moved by each predetermined amount in the raster scanning manner, from a start position (an upper left position) toward an ending position (a lower right position) of the search area (see FIG. 8). Moreover, the size of the face-detection frame structure FD is reduced by a scale of “5” from “SZmax” to “SZmin” at every time the face-detection frame structure FD reaches the ending position.

Apart of the first search image data belonging to the face-detection frame structure FD is read out from the first search image area 32d through the memory control circuit 30. A characteristic amount of the read-out image data is compared with a characteristic amount of each of the five dictionary images contained in the face dictionary FDC. When a matching degree exceeding a threshold value TH is obtained, it is regarded that the face image has been detected. A position and a size of the face-detection frame structure FD at a current time point is registered as face information, in the first work register RGSTwkL shown in FIG. 9.

When there is a registration of the face information in the first work register RGSTwkL after the face detecting process is completed, a registration content of the first work register RGSTwkL is copied on the first face-detection register RGSTdtL shown in FIG. 9. Moreover, in order to declare that the face image of the person has been discovered, the CPU 26 sets the flag FLG_L to “1”.

It is noted that, when there is no registration of the face information in the first face detection register RGSTdtL upon completion of the face detecting process, that is, when the face of the person is not discovered, the CPU 26 sets the flag FLG_L to “0” in order to declare that the face of the person is undiscovered.

Under a second face detecting task executed in parallel with the imaging task and the first face detecting task, the CPU 26 clears a registration content in order to initialize each of a second face-detection register RGSTdtR, a low-luminance-face detection register RGSTbr1 and a high-luminance-face register RGSTbr2, and sets a flag FLG_R to “0” as an initial setting.

Subsequently, an exposure setting of the R-side imaging block is changed to the same setting as the L-side imaging block. Thus, the CPU 26 sets the same aperture amount as an aperture amount set to the driver 18b to the driver 58b, and sets the same exposure time period as an exposure time period set to the driver 18c to the driver 58c.

Upon completion of changing the exposure setting, the CPU 26 acquires the 256 AE evaluation values corresponding to the R-side imaging block from the AE evaluating circuit 22. Subsequently, the CPU 26 extracts a low-luminance region ARL and a high-luminance region ARH, based on the acquired AE evaluation values.

For example, a region in which a block, indicating a luminance equal to or less than a threshold value, laterally continues equal to or more than two blocks and longitudinally continues equal to or more than two blocks is extracted as the low-luminance region ARL. Moreover, a region in which a block, indicating a luminance equal to or more than the threshold value, laterally continues equal to or more than two blocks and longitudinally continues equal to or more than two blocks is extracted as the high-luminance region ARH.

When the low-luminance region ARL is discovered, the CPU 26 executes the face detecting process by using the extracted the low-luminance region ARL as the search area, at every time the vertical synchronization signal Vsync is generated. It is noted that a second work register RGSTwkR shown in FIG. 9 is designated as a registration destination of a search result.

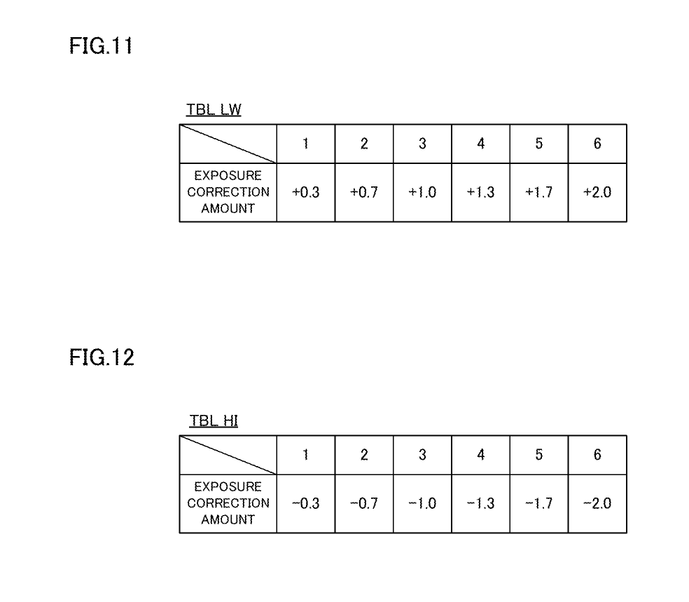

In the face detecting process in the low-luminance region ARL, used is a low-luminance exposure-correction amount table TBL_LW shown in FIG. 11. As shown in FIG. 11, in the low-luminance exposure-correction amount table TBL_LW, registered are six types of exposure correction amounts of which the correction amount becomes greater from the first toward the sixth to a high-luminance side. It is noted that the low-luminance exposure-correction amount table TBL_LW is stored in the flash memory 44.

Subsequently, the CPU 26 corrects the exposure setting of the R-side imaging block based on each of the six types of exposure correction amounts registered in the low-luminance exposure-correction amount table TBL_LW. An aperture amount and an exposure time period that define the corrected EV value are set to the drivers 58b and 58c, respectively. As a result, a brightness of the second search image data is corrected to the high-luminance side. Upon completion of the correction, the face detecting process same as the described above is executed at every time the vertical synchronization signal Vsync is generated.

It is determined whether or not the face information is registered in the second work register RGSTwkR at every time a single face detecting process is completed, and when there is a registration in the second work register RGSTwkR, the face detecting process in the low-luminance region ARL is ended. Moreover, a registration content of the second work register RGSTwkR is copied on the low-luminance-face detection register RGSTbr1 shown in FIG. 9.

When the high-luminance region ARH is discovered, the CPU 26 executes the face detecting process by using the extracted the high-luminance region ARH as the search area, at every time the vertical synchronization signal Vsync is generated. It is noted that a second work register RGSTwkR is designated as a registration destination of a search result.

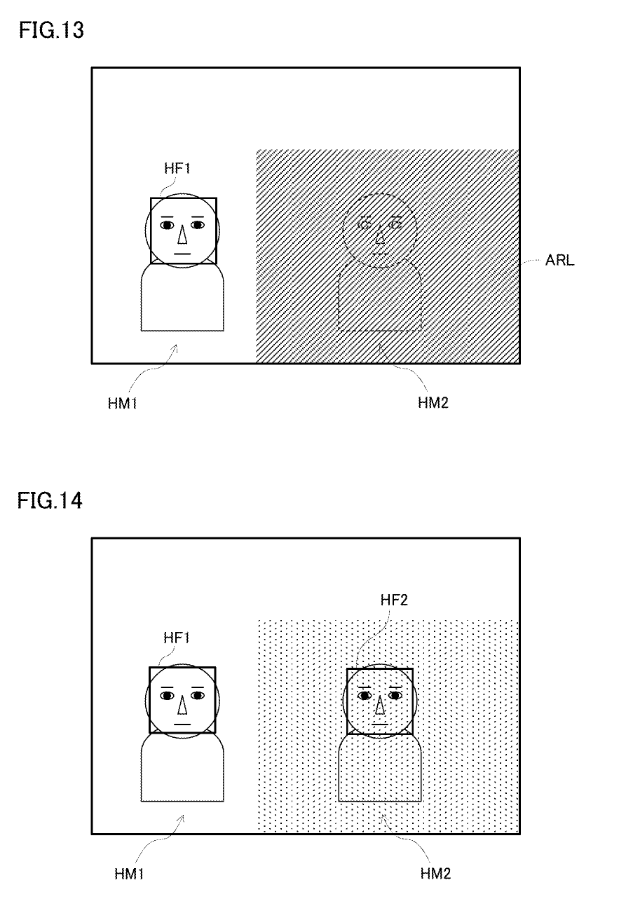

In the face detecting process in the high-luminance region ARH, used is a high-luminance exposure-correction amount table TBL_HI shown in FIG. 12. As shown in FIG. 12, in the high-luminance exposure-correction amount table TBL_HI, registered are six types of exposure correction amounts of which the correction amount becomes greater from the first toward the sixth to a low-luminance side. It is noted that the high-luminance exposure-correction amount table TBL_HI is stored in the flash memory 44.

Subsequently, the CPU 26 corrects the exposure setting of the R-side imaging block based on each of the six types of exposure correction amounts registered in the high-luminance exposure-correction amount table TBL_HI. An aperture amount and an exposure time period that define the corrected EV value are set to the drivers 58b and 58c, respectively. As a result, the brightness of the second search image data is corrected to the low-luminance side. Upon completion of the correction, the face detecting process same as the described above is executed at every time the vertical synchronization signal Vsync is generated.

It is determined whether or not the face information is registered in the second work register RGSTwkR at every time the single face detecting process is completed, and when there is a registration of the face information in the second work register RGSTwkR, the face detecting process in the high-luminance region ARH is ended. Moreover, the registration content of the second work register RGSTwkR is copied on the high-luminance-face detection register RGSTbr2 shown in FIG. 9.

When there is a registration of the face information in the low-luminance-face detection register RGSTbr1 or the high-luminance-face detection register RGSTbr2 after the face detecting process in the high-luminance region ARH or the low-luminance region ARL is completed, each registration content is integrated into the second face-detection register RGSTdtR. Moreover, in order to declare that the face image of the person has been discovered, the CPU 26 sets the flag FLG_R to “1”.

When a shutter button 28sh is in a non-operated state, the CPU 26 executes a following process under the imaging task. When the flag FLG_L indicates “1”, the registration content of the first face-detection register RGSTdtL is copied on an AE target register RGSTae shown in FIG. 9.

Here, a face position registered in the second face-detection register RGSTdtR indicates a position in a scene captured by the R-side imaging block. When the flag FLG_R indicates “1”, the CPU 26 corrects the face position registered in the second face-detection register RGSTdtR to a position in a scene captured by the L-side imaging block. A correction amount of the face position is determined based on a face size corresponding to the interval between the optical axis AX_L of the Inside imaging block and the optical axis AX_R of the R-side imaging block and a face position of a correction target.

The registration content of the second face-detection register RGSTdtR in which the face position is corrected is integrated into the AE target register RGSTae. At this time, out of the corrected face information of the second face-detection register RGSTdtR, face information of which the position and size is coincident with any of the face information already registered in the AE target register RGSTae indicates the same face as the face information already registered. Thus, the face information is not newly registered on the AE target register RGSTae.

As a result of undergoing these processes, when there is no registration of the face information in the AE target register RGSTae, the CPU 26 executes, a simple AE process that is based on the AE evaluation values outputted from the AE evaluating circuit 22 corresponding to the first RGB data, to the L-side imaging block so as to calculate an appropriate EV value. The simple AE process is executed in parallel with the moving image taking process, and an aperture amount and an exposure time period that define the calculated appropriate EV value are set to the drivers 18b and 18c, respectively. As a result, a brightness of the live view image is adjusted approximately.

When the face information is registered in the AE target register RGSTae, the CPU 26 requests a graphic generator 46 to display a face frame structure HF with reference to the registration content of the AE target register RGSTae. The graphic generator 46 outputs graphic information representing the face frame structure HF toward the LCD driver 36. As a result, as shown in FIG. 13, FIG. 14 and FIG. 16, the face frame structure HF is displayed on the LCD monitor 38 in a manner to be adapted to a position and a size of a face image on a live view image.

Moreover, when the face information is registered on the AE target register RGSTae, the CPU 26 extracts AE evaluation values corresponding to the position and size registered in the AE target register RGSTae, out of the AE evaluation values outputted from the AE evaluating circuit 22 corresponding to the first RGB data. The CPU 26 executes a strict AE process that is based on the extracted partial AE evaluation values, to the L-side imaging block. An aperture amount and an exposure time period that define an optimal EV value calculated by the strictAE process are set to the drivers 18b and 18c, respectively. As a result, the brightness of the live view image is adjusted to a brightness in which the position registered in the AE target register RGSTae, i. e., a part of a scene equivalent to the face position detected by each of the first face detecting task and the second face detecting task is noticed.

With reference to FIG. 13, a face image of a person HM1 is discovered by the face detecting process executed under the first face detecting task, and face information is registered on the AE target register RGSTae. Therefore, a face frame structure HF1 is displayed on the LCD monitor 38. However, a face image of a person HM2 existing in the low-luminance region ARL generated by a shade of a building, etc., is not discovered before the correcting process for the exposure setting of the R-side imaging block is executed under the second face detecting task.

However, with reference to FIG. 14, when the exposure setting of the R-side imaging block is corrected to the high-luminance side, the face image of the person HM2 is discovered by the face detecting process executed under the second face detecting task. Thereby, face information of the person HM2 is registered on the AE target register RGSTae, and therefore, a face frame structure HF2 is displayed on the LCD monitor 38, together with the face frame structure HF1.

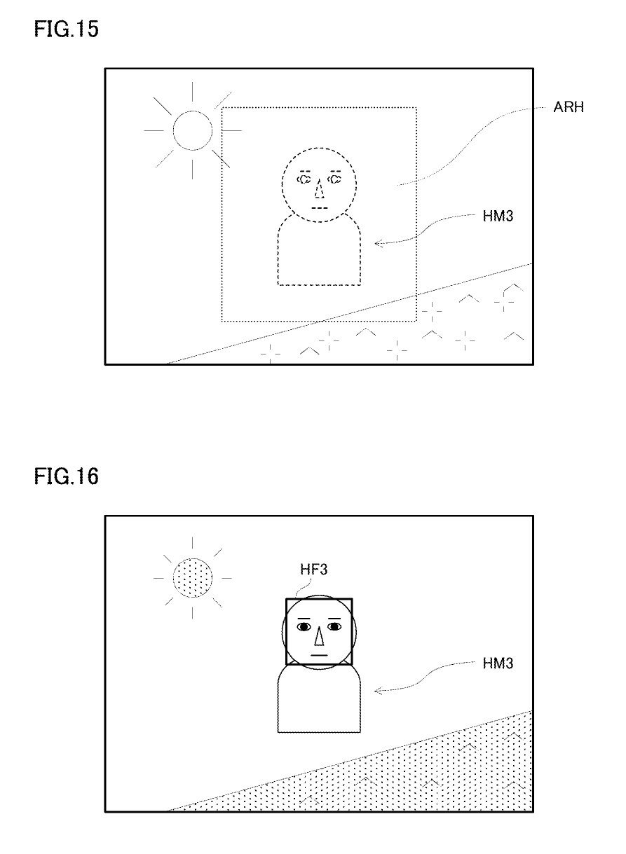

With reference to FIG. 15, even when a person HM 3 exists in a scene captured by each of the L-side imaging block and the R-side imaging block, in a case where a position of the person HM3 is included in the high-luminance region ARH generated by such as the reflected light from sunlight and a water surface, a face image of the person HM3 is not discovered by the face detecting process executed under the first face detecting process.

However, with reference to FIG. 16, when the exposure setting of the R-side imaging block is corrected to the low-luminance side, the face image of the person HM3 is discovered by the face detecting process executed under the second face detecting task. Thereby, face information of the person HM3 is registered on the AE target register RGSTae, and therefore, a face frame structure HF3 is displayed on the LCD monitor 38.

Moreover, when the face information is registered on the AE target register RGSTae, the CPU 26 determines an AF target region from among the regions indicated by the positions and sizes registered in the AE target register RGSTae. When a piece of face information is registered in the AE target register RGSTae, the CPU 26 uses the region indicated by the registered position and size as the AF target region. When a plurality of face information are registered in the AE target register RGSTae, the CPU 26 uses a region indicated by the face information having the largest size as the AF target region. When a plurality of face information indicating the maximum size is registered, the CPU 26 uses a region nearest to a center of the scene out of the regions indicated by these face information as the AF target region. A position and a size of the face information used as the AF target region is registered on an AF target register RGSTaf shown in FIG. 10.

When the shutter button 28sh is half-depressed, the CPU 26 executes an AF process to the L-side imaging block. When there is no registration of the face information in the AF target register RGSTaf, i.e., when the face image is not detected, the CPU 26 extracts, out of the 256 AF evaluation values outputted from the AF evaluating circuit 24, AF evaluation values corresponding to a predetermined region of the center of the scene. The CPU 26 executes an AF process that is based on the extracted partial AF evaluation values. As a result, the focus lens 12 is placed at a focal point in which the center of the scene is noticed, and thereby, a sharpness of the live view image is improved.

When the face information is registered on the AF target register RGSTaf, i.e., when the face image is detected, the CPU 26 executes an AF process in which the AF target region is noticed. The CPU 26 extracts AF evaluation values corresponding to the position and size registered in the AF target register RGSTaf, out of the 256 AF evaluation values outputted from the AF evaluating circuit 24. The CPU 26 executes an AF process that is based on the extracted partial AF evaluation values. As a result, the focus lens 12 is placed at a focal point in which the AF target region is noticed, and thereby, a sharpness of AF target region in the live view image is improved.

Upon completion of the AF process executed to the Inside imaging block, the CPU 26 changes a focus setting of the R-side imaging block to the same setting as the L-side imaging block. Thus, the CPU 26 commands the driver 58a to move the focus lens 52, and the driver 58a places the focus lens 52 at a lens position indicating the same focal length as a focal length set to the L-side imaging block.

When the shutter button 28sh is fully depressed in a case where the imaging mode is set to the normal recording mode, under the imaging task, the CPU 26 executes a still-image taking process and a recording process of the L-side imaging block. One frame of the first raw image data at a time point at which the shutter button 28sh is fully depressed is taken into a first still image area 32f of the SDRAM 32 shown in FIG. 4, by the still-image taking process. The taken one frame of the first raw image data is read out from the first still image area 32f by an I/F 40 activated in association with the recording process, and is recorded on the recording medium 42 in a file format.

When the shutter button 28sh is fully depressed in a case where the imaging mode is set to the 3D recording mode, in order to suspend the correcting process for the exposure setting of the R-side imaging block, the CPU 26 stops the second face detecting task once.

Subsequently, the exposure setting of the R-side imaging block is changed to the same setting as the L-side imaging block. Thus, the CPU 26 sets the same aperture amount as the aperture amount set to the driver 18b to the driver 58b, and sets the same exposure time period as the exposure time period set to the driver 18c to the driver 58c.

Upon completion of changing the exposure setting of the R-side imaging block, under the imaging task, the CPU 26 executes the still-image taking process and the 3D recording process of each of the L-side imaging block and the R-side imaging block. One frame of the first raw image data and one frame of the second raw image data at a time point at which the shutter button 28sh is fully depressed are respectively taken into the first still image area 32f and a second still image area 32g of the SDRAM 32 shown in FIG. 4, by the still-image taking process.

Moreover, one still image file having a format corresponding to recording of a 3D still image is created in a recording medium 42, by the 3D recording process. The taken first raw image data and second raw image data are recorded in the newly created still image file together with an identification code indicating accommodation of the 3D image and a method of arranging two images. Upon completion of the 3D recording process, the CPU 26 restarts the second face detecting task.

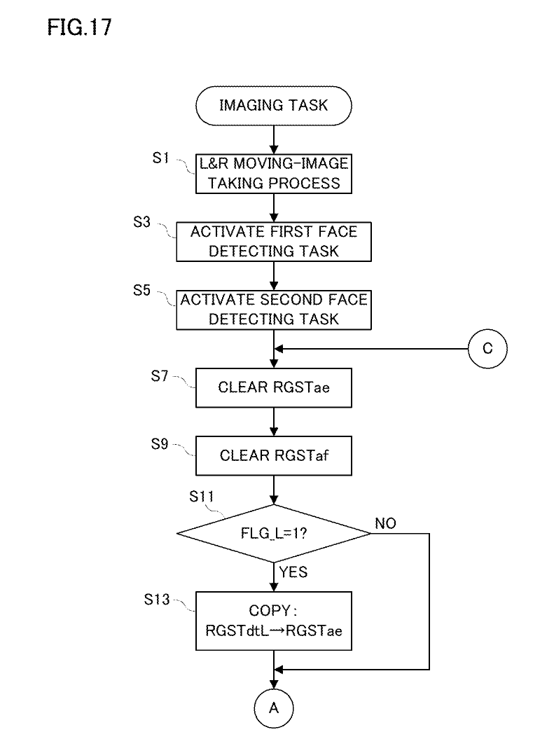

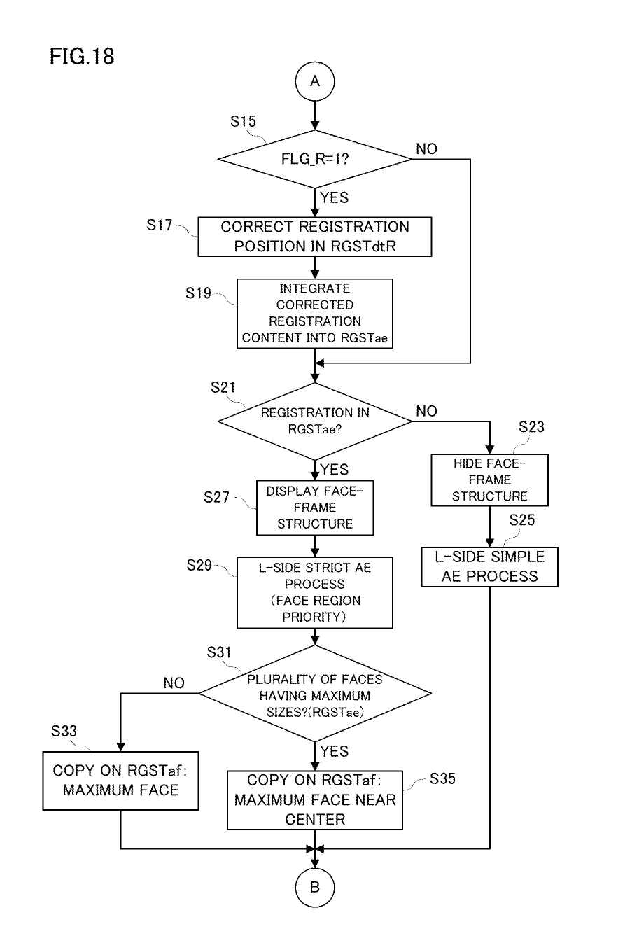

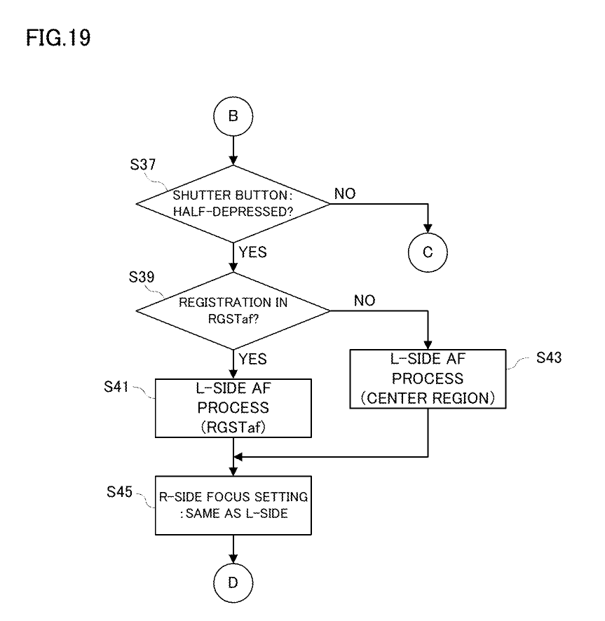

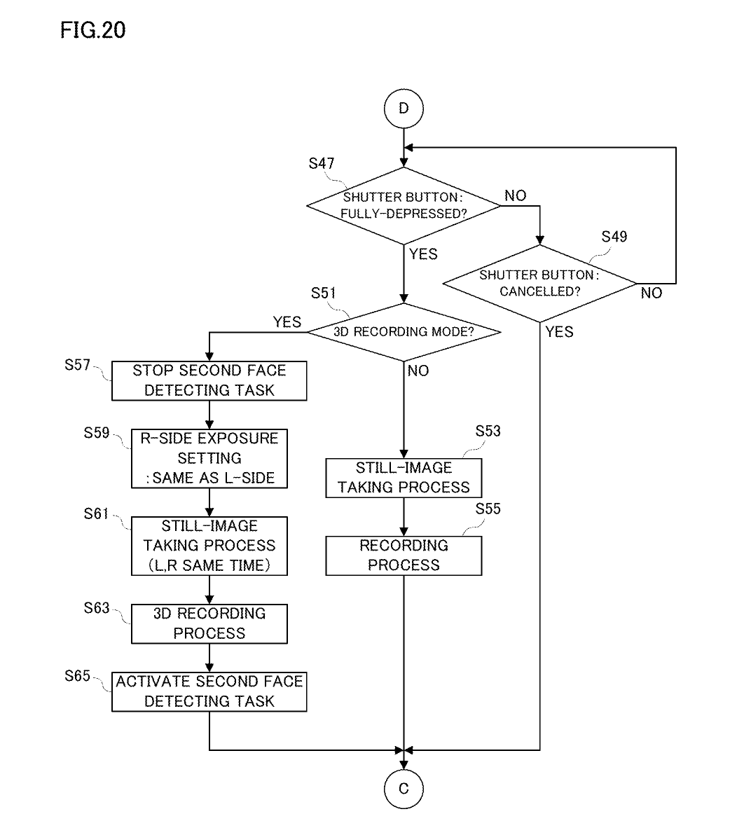

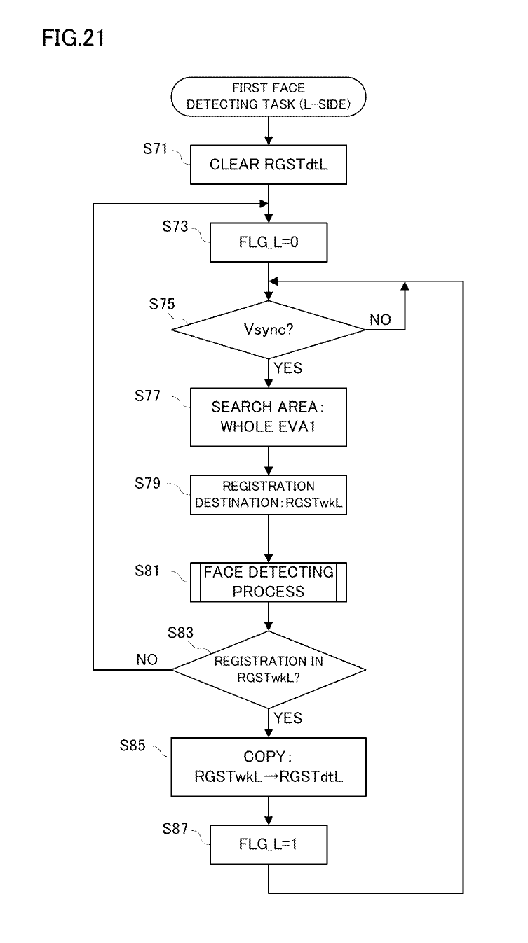

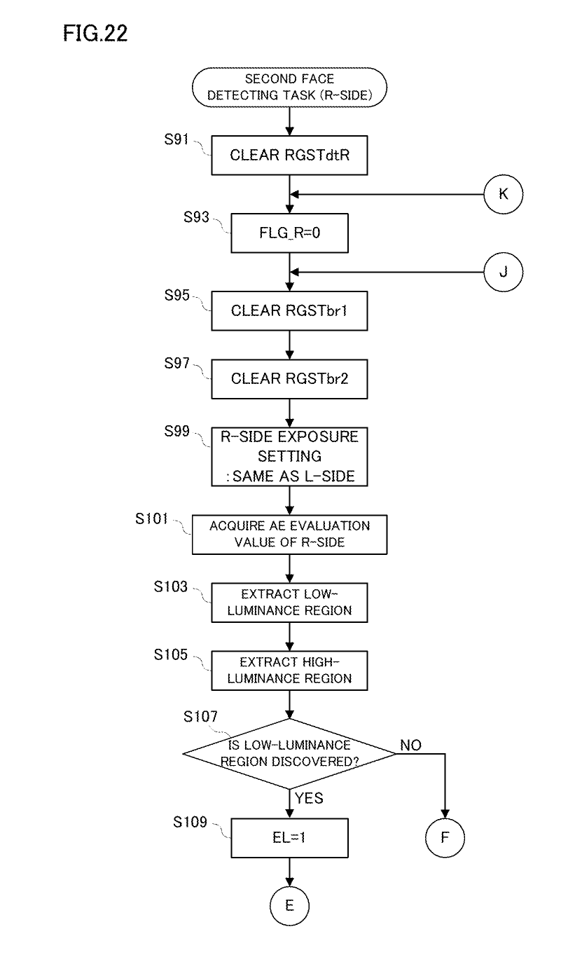

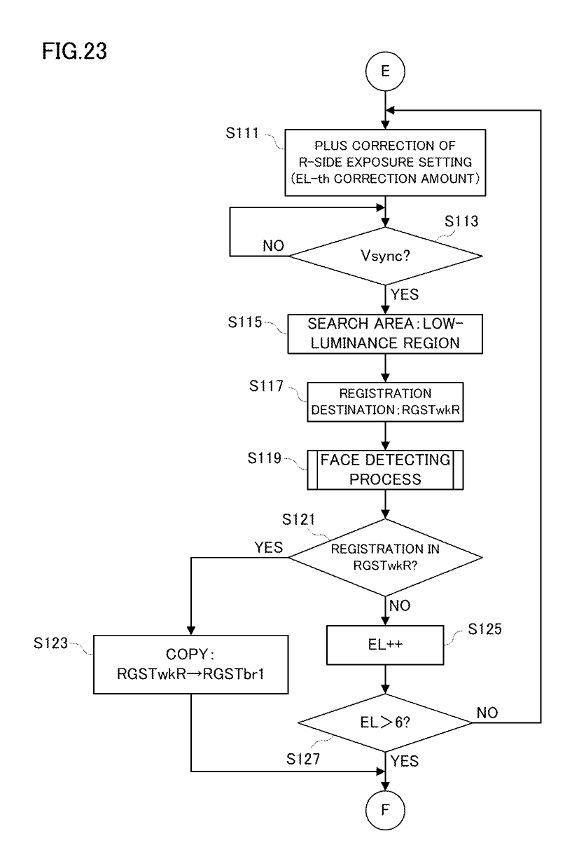

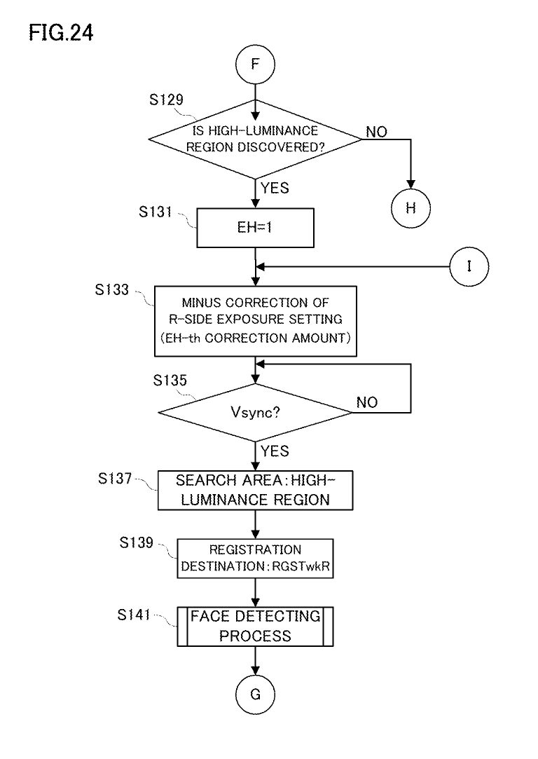

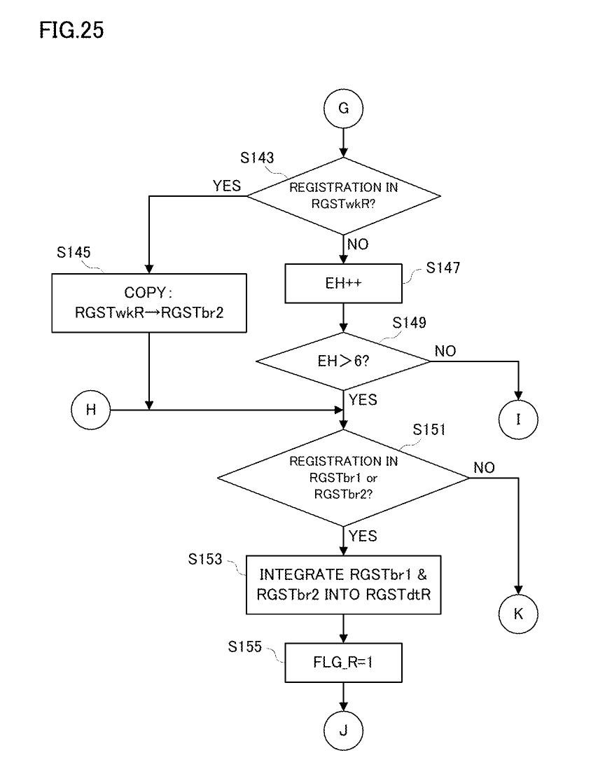

The CPU 26 executes a plurality of tasks including the imaging task shown in FIG. 17 to FIG. 20, the first face detecting task shown in FIG. 21 and the second face detecting task shown in FIG. 22 to FIG. 25, in a parallel manner. It is noted that control programs corresponding to these tasks are stored in the flash memory 44.

With reference to FIG. 17, in a step S1, the moving-image taking process is executed. As a result, a live view image representing a scene is displayed on the LCD monitor 38. In a step S3, the first face detecting task is activated, and in a step S5, the second face detecting task is activated.

In a step S7, a registration content of the AE target register RGSTae is cleared, and in a step S9, a registration content of the AF target register RGSTaf is cleared.

In a step S11, it is determined whether or not the flag FLG_L is set to “1”, and when a determined result is NO, the process advances to a step S15 whereas when the determined result is YES, in a step S13, a registration content of the first face-detection register RGSTdtL is copied on the AE target register RGSTae.

In a step S15, it is determined whether or not the flag FLG_R is set to “1”, and when a determined result is NO, the process advances to a step S21 whereas when the determined result is YES, the process advances to the step S21 via processes in steps S17 and S19.

In the step S17, a face position registered in the second face-detection register RGSTdtR is corrected to a position in a scene captured by the L-side imaging block. A correction amount of the face position is determined based on a face size corresponding to the interval between the optical axis AX_L of the L-side imaging block and the optical axis AX_R of the R-side imaging block and a face position of a correction target. In a step S19, the registration content of the second face-detection register RGSTdtR in which the face position is corrected in the step S17 is integrated into the AE target register RGSTae.

In a step S21, it is determined whether or not there is a registration of face information in the AE target register RGSTae, and when a determined result is YES, the process advances to a step S27 whereas when the determined result is NO, the process advances to a step S37 via processes in steps S23 and S25.

In the step S23, the graphic generator 46 is requested to hide the face frame structure HF. As a result, the face frame structure HF displayed on the LCD monitor 38 is hidden.

In a step S25, the simple AE process of the L-side imaging block is executed. An aperture amount and an exposure time period that define the appropriate EV value calculated by the simple AE process are set to the drivers 18b and 18c, respectively. As a result, a brightness of the live view image is adjusted approximately.

In a step S27, the graphic generator 46 is requested to display the face frame structure HF with reference to the registration content of the AE target register RGSTae. As a result, the face frame structure HF is displayed on the LCD monitor 38 in a manner to be adapted to a position and a size of a face image detected under each of the first face detecting task and the second face detecting task.

In a step S29, executed is the strict AE process corresponding to the position and size registered in the AE target register RGSTae. An aperture amount and an exposure time period that define the optimal EV value calculated by the strict AE process are set to the drivers 18b and 18c, respectively. As a result, the brightness of the live view image is adjusted to a brightness in which the position registered in the AE target register RGSTae, i. e., a part of a scene equivalent to the face position detected by each of the first face detecting task and the second face detecting task is noticed.

In a step S31, it is determined whether or not there are a plurality of face information having the largest sizes out of the face information registered in the AE target register RGSTae. When a determined result is NO, in a step S33, the face information having the largest size is copied on the AF target register RGSTaf.

When the determined result is YES, in a step S35, face information having a position nearest to the center of the imaging surface out of the plurality of the face information having the maximum sizes is copied on the AF target register RGSTaf. Upon completion of the process in the step S33 or S35, the process advances to the step S37.

In the step S37, it is determined whether or not the shutter button 28sh is half-depressed, and when a determined result is NO, the process returns to the step S7 whereas when the determined result is YES, the process advances to a step S39. In the step S39, it is determined whether or not there is the registration of the face information in the AF target register RGSTaf, and when a determined result is YES, the process advances to a step S45 via a process in a step S41 whereas when the determined result is NO, the process advances to the step S45 via a process in a step S43.

In the step S41, the AF process is executed based on AF evaluation values corresponding to the position and size registered in the AF target register RGSTaf, out of the AF evaluation values of the L-side imaging block. As a result, the focus lens 12 is placed at a focal point in which a face position of a person used as a target of the AF process is noticed, and thereby, a sharpness of the live view image is improved.

In the step S43, the AF process is executed based on AF evaluation values corresponding to a predetermined region of the center of the scene out of the AF evaluation values of the L-side imaging block. As a result, the focus lens 12 is placed at a focal point in which the center of the scene is noticed, and thereby, a sharpness of the live view image is improved.

In the step S45, the focus setting of the R-side imaging block is changed to the same setting as the L-side imaging block. As a result, the focus lens 52 is placed at a lens position indicating the same focal length as a focal length set to the Inside imaging block.

In a step S47, it is determined whether or not the shutter button 28sh is fully depressed, and when a determined result is NO, in a step S49, it is determined whether or not the shutter button 28sh is cancelled. When a determined result of the step S49 is NO, the process returns to the step S47 whereas when the determined result of the step S49 is YES, the process returns to the step S7.

When a determined result of the step S47 is YES, in a step S51, it is determined whether or not the imaging mode is set to the 3D recording mode. When a determined result is YES, the process returns to the step S7 via processes in steps S57 to S65 whereas when the determined result is NO, the process returns to the step S7 via processes in steps S53 and S55.

In the step S53, the still-image taking process is executed, and in the step S55, the recording process is executed. One frame of image data at a time point at which the shutter button 28sh is fully depressed is taken into a first still image area 32f by the still-image taking process. The taken one frame of the image data is read out from the first still image area 32f by the I/F 40 activated in association with the recording process, and is recorded on the recording medium 42 in a file format.

In the step S57, the second face detecting task is stopped in order to suspend the correcting process for the exposure setting of the R-side imaging block. In the step S59, the exposure setting of the R-side imaging block is changed to the same setting as the L-side imaging block. Thus, the same aperture amount as the aperture amount set to the driver 18b is set to the driver 58b, and the same exposure time period as the exposure time period set to the driver 18c is set to the driver 58c.

In the step S61, the still-image taking process of each of the Inside imaging block and the R-side imaging block is executed. As a result, one frame of first raw image data and one frame of second raw image data at a time point at which the shutter button 28sh is fully depressed are respectively taken into the first still image area 32f and the second still image area 32g by the still-image taking process.

In the step S63, the 3D recording process is executed. As a result, one still image file having a format corresponding to recording of a 3D still image is created in the recording medium 42. The taken first raw image data and second raw image data are recorded by the recording process in the newly created still image file together with an identification code indicating accommodation of the 3D image and a method of arranging two images. In the step S65, the second face detecting task is activated.

With reference to FIG. 21, in a step S71, a registration content is cleared in order to initialize the first face-detection register RGSTdtL, and in a step S73, the flag FLG_L is set to “0”.

In a step S75, it is repeatedly determined whether or not the vertical synchronization signal Vsync is generated, and when a determined result is updated from NO to YES, in a step S77, the whole evaluation area EVA1 is designated as a search area for the face detecting process. In a step S79, the first work register RGSTwkL is designated as a registration destination of a search result of the face detecting process.

In a step S81, the face detecting process of the Inside imaging block. Upon completion of the face detecting process, in a step S83, it is determined whether or not there is a registration of the face information in the first work register RGSTwkL, and when a determined result is NO, the process returns to the step S73 whereas when the determined result is YES, the process advances to a step S85.

In the step S85, a registration content of the first work register RGSTwkL is copied on the first face-detection register RGSTdtL. In a step S87, the flag FLG_L is set to “1” in order to declare that the face of the person has been discovered, and thereafter, the process returns to the step S75.

With reference to FIG. 22, in a step S91, a registration content is cleared in order to initialize the second face-detection register RGSTdtR, and in a step S93, the flag FLG_R is set to “0”. In a step S95, a registration content of the low-luminance-face detection register RGSTbr1 is cleared, and in a step S97, a registration content of a high-luminance-face register RGSTbr2 is cleared.

In a step S99, the exposure setting of the R-side imaging block is changed to the same setting as the L-side imaging block. Thus, the same aperture amount as an aperture amount set to the driver 18b is set to the driver 58b, and sets the same exposure time period as an exposure time period set to the driver 18c to the driver 58c

In a step S101, 256 AE evaluation values corresponding to the R-side imaging block are acquired from the AE evaluating circuit 22. Based on the acquired AE evaluation values, the low-luminance region ARL is extracted in a step S103, and the high-luminance region ARH is extracted in a step S105.

For example, a region in which a block, indicating a luminance equal to or less than the threshold value, laterally continues equal to or more than two blocks and longitudinally continues equal to or more than two blocks is extracted as the low-luminance region ARL. Moreover, a region in which a block, indicating a luminance equal to or more than the threshold value, laterally continues equal to or more than two blocks and longitudinally continues equal to or more than two blocks is extracted as the high-luminance region ARH.

In a step S107, it is determined whether or not the low-luminance region ARL has discovered, and when a determined result is NO, the process advances to a step S129 whereas when the determined result is YES, in a step S109, a variable EL is set to “1”. In a step S111, the exposure setting of the R-side imaging block is corrected to the high-luminance side based on the EL-th exposure correction amount registered in the low-luminance exposure-correction amount table TBL_LW. An aperture amount and an exposure time period that define the corrected EV value are set to the drivers 18b and 18c, respectively. As a result, a brightness of the second search image data is corrected to the high-luminance side.

In a step S113, it is repeatedly determined whether or not the vertical synchronization signal Vsync is generated, and when a determined result is updated from NO to YES, in a step S115, the low-luminance region ARL is designated as a search area for the face detecting process. In a step S117, the second work register RGSTwkR is designated as a registration destination of a search result of the face detecting process.

In a step S119, the face detecting process in the low-luminance region ARL is executed. Upon completion of the face detecting process, in a step S121, it is determined whether or not there is a registration of the face information in the second work register RGSTwkR, and when a determined result is NO, the process advances to a step S125 whereas when the determined result is YES, the process advances to a step S123.

In the step S123, a registration content of the second work register RGSTwkR is copied on the low-luminance-face detection register RGSTbr1, and thereafter, the process advances to the step S129.

In the step S125, the variable EL is incremented, and in a step S127, it is determined whether or not the variable EL exceeds “6”. When a determined result is NO, the process returns to the step S111 whereas when the determined result is YES, the process advances to the step S129.

In the step S129, it is determined whether or not the high-luminance region ARH is discovered, and when a determined result is NO, the process advances to a step S151, and when the determined result is YES, in a step S131, a variable EH is set to “1”. In a step S133, the exposure setting of the R-side imaging block is corrected to the low-luminance side based on the EH-th exposure correction amount registered in the high-luminance exposure-correction amount table TBL_HI. An aperture amount and an exposure time period that define the corrected EV value are set to the drivers 18b and 18c, respectively. As a result, a brightness of the second search image data is corrected to the low-luminance side.

In a step S135, it is repeatedly determined whether or not the vertical synchronization signal Vsync is generated, and when a determined result is updated from NO to YES, in a step S137, the high-luminance region ARH is designated as a search area for the face detecting process. In a step S139, the second work register RGSTwkR is designated as a registration destination of a search result of the face detecting process.

In a step S141, the face detecting process in the high-luminance region ARH is executed. Upon completion of the face detecting process, in a step S143, it is determined whether or not there is a registration of the face information in the second work register RGSTwkR, and when a determined result is NO, the process advances to a step S147 whereas when the determined result is YES, the process advances to a step S145.

In the step S145, a registration content of the second work register RGSTwkR is copied on the high-luminance-face detection register RGSTbr2, and thereafter, the process advances to the step S151.

In the step S147, the variable EH is incremented, and in a step S149, it is determined whether or not the variable EH exceeds “6”. When a determined result is NO, the process returns to the step S133 whereas when the determined result is YES, the process advances to the step S151.

In the step S151, it is determined whether or not there is a registration of the face information in the low-luminance-face detection register RGSTbr1 or the high-luminance-face detection register RGSTbr2, and when a determined result is YES, the process advances to a step S153 whereas when the determined result is NO, the process returns to the step S93.

In a step S153, the registration content of each of the low-luminance-face detection register RGSTbr1 and the high-luminance-face register RGSTbr2 is integrated into the second face-detection register RGSTdtR. In a step S155, in order to declare that the face image of the person has been discovered, the flag FLG_R is set to “1”. Thereafter, the process returns to the step S95.

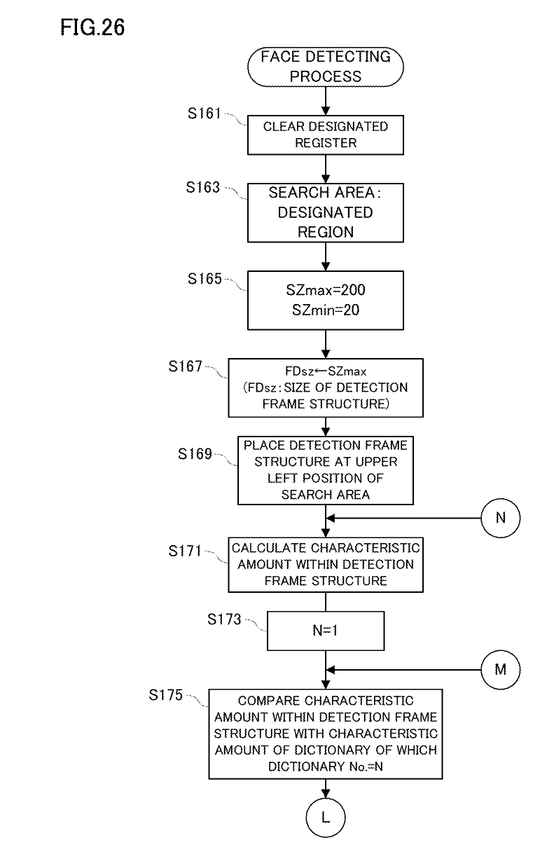

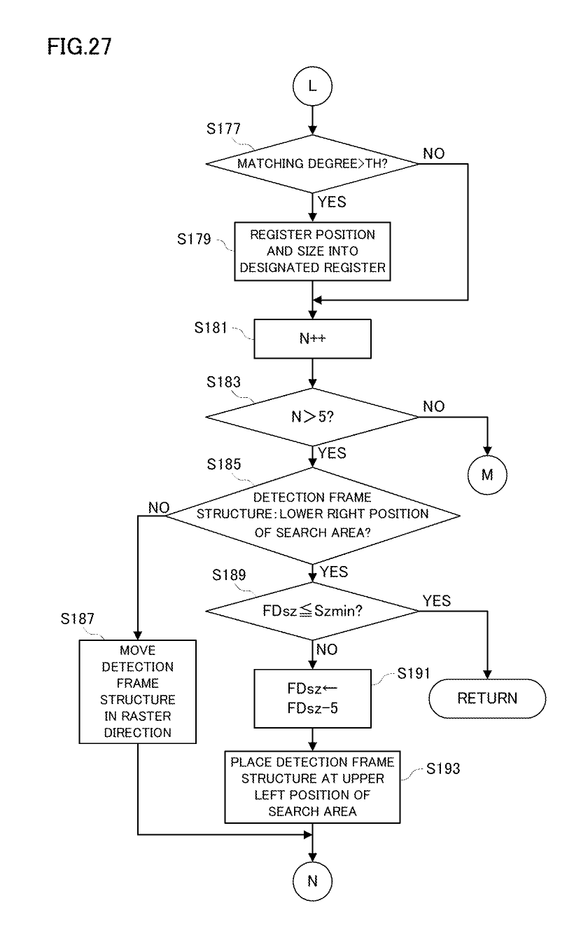

The face detecting process in the steps S81, S119 and S141 is executed according to a subroutine shown in FIG. 26 to FIG. 27. In a step S161, a registration content is cleared in order to initialize the register designated during execution of the face detecting process.

In a step S163, the region designated during execution of the face detecting process is set as the search area. In the step S165, in order to define the variable range of the size of the face-detection frame structure FD, the maximum size SZmax is set to “200”, and the minimum size SZmin is set to “20”.

In a step S167, the size of the face-detection frame structure FD is set to “SZmax”, and in a step S169, the face-detection frame structure FD is placed at the upper left position of the search area. In a step S171, a part of the search image data belonging to the face-detection frame structure FD is read out from the first search image area 32d or the second search image area 32e so as to calculate a characteristic amount of the read-out search image data.

In a step S173, a variable N is set to “1”, and in a step S175, the characteristic amount calculated in the step S171 is compared with a characteristic amount of the dictionary image of which a dictionary number is N, in the face dictionary FDC. As a result of comparing, in a step S177, it is determined whether or not a matching degree exceeding the threshold value TH is obtained, and when a determined result is NO, the process advances to a step S181 whereas when the determined result is YES, the process advances to the step S181 via a process in a step S179.

In the step S179, a position and a size of the face-detection frame structure FD at a current time point are registered, as face information, in the designated register.

In the step S181, the variable N is incremented, and in a step S183, it is determined whether or not the variable N has exceeded “5”. When a determined result is NO, the process returns to the step S175 whereas when the determined result is YES, in a step S185, it is determined whether or not the face-detection frame structure FD has reached the lower right position of the search area.

When a determined result of the step S185 is YES, in a step S187, the face-detection frame structure FD is moved by a predetermined amount in a raster direction, and thereafter, the process returns to the step S171. When the determined result of the step S185 is YES, in a step S189, it is determined whether or not the size of the face-detection frame structure FD is equal to or less than “SZmin”. When a determined result of the step S189 is NO, in a step S191, the size of the face-detection frame structure FD is reduced by a scale of “5”, and in a step S193, the face-detection frame structure FD is placed at the upper left position of the search area. Thereafter, the process returns to the step S171. When the determined result of the step S189 is YES, the process returns to the routine in an upper hierarchy.

As can be seen from the above-described explanation, each of the image sensor s16 and 56 outputs the image representing the common scene. The CPU 26 searches for a partial image satisfying the predetermined condition from the image outputted from a part of the image sensors 16 and 56, and adjusts the imaging condition of another part of the image sensors 16 and 56 to the condition different from the imaging condition at a time point at which the searching process is executed. Moreover, the CPU 26 executes the process of searching for the partial image satisfying the predetermined condition from the image outputted from the image sensor noticed by the adjusting process, in association with the adjusting process, and adjusts the imaging condition of at least a part of the image sensors 16 and 56 by noticing the partial image detected by the searching process.

The partial image satisfying the predetermined condition is searched from the image outputted from a part of the plurality of image sensors. The imaging condition of the another part of the image sensors is adjusted to the condition different from the condition at a time point at which the searching process is executed, and the partial image is searched from the image outputted from the image sensor subjected to the adjusting process. Thus, the imaging condition of the image sensor is adjusted by noticing the partial image detected by each searching process.

As a result, since the searching process is executed under each of the plurality of imaging conditions, it becomes possible to discover the partial image without missing, and the imaging condition of the image sensor is adjusted by noticing the detected partial image. Therefore, it becomes possible to improve the imaging performance.

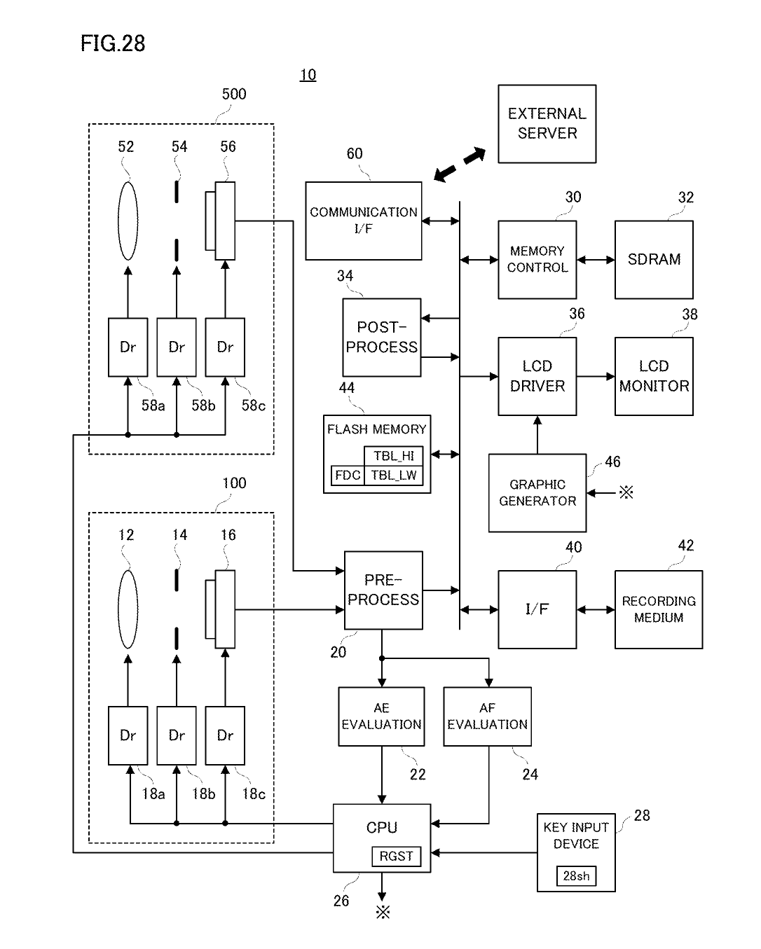

It is noted that, in this embodiment, the control programs equivalent to the multi task operating system and the plurality of tasks executed thereby are previously stored in the flash memory 44. However, a communication I/F 60 may be arranged in the digital camera 10 as shown in FIG. 28 so as to initially prepare a part of the control programs in the flash memory 44 as an internal control program whereas acquire another part of the control programs from an external server as an external control program. In this case, the above-described procedures are realized in cooperation with the internal control program and the external control program.

Moreover, in this embodiment, the processes executed by the CPU 26 are divided into a plurality of tasks including the imaging task shown in FIG. 17 to FIG. 20, the first face detecting task shown in FIG. 21 and the second face detecting task shown in FIG. 22 to FIG. 25. However, these tasks may be further divided into a plurality of small tasks, and furthermore, a part of the divided plurality of small tasks may be integrated into another task. Moreover, when a transferring tasks is divided into the plurality of small tasks, the whole task or a part of the task may be acquired from the external server.

Moreover, in this embodiment, two imaging blocks respectively including two image sensors are arranged so as to execute the searching process based on output of each of the imaging block. However, one or at least two imaging block may further be arranged so as to execute the searching process after correcting exposure settings of the added imaging blocks.

Moreover, in this embodiment, the present invention is explained by using a digital still camera, however, a digital video camera, cell phone units or a smartphone may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
a plurality of imagers each of which outputs an image representing a common scene;
a first searcher which searches for a partial image satisfying a predetermined condition from the image outputted from a part of said plurality of imagers;
a first adjuster which adjusts an imaging condition of another part of said plurality of imagers to a condition different from an imaging condition at a time point at which a process of said first searcher is executed;
a second searcher which searches for the partial image satisfying the predetermined condition from an image outputted from an imager noticed by said first adjuster, in association with an adjusting process of said first adjuster; and
a second adjuster which adjusts an imaging condition of at least a part of said plurality of imagers by noticing the partial image detected by said first searcher and/or said second searcher.

2. An electronic camera according to claim 1, wherein the imaging condition adjusted by said first adjuster includes an exposure amount.

3. An electronic camera according to claim 1, wherein said first adjuster includes an imaging setting value selector which sequentially selects a plurality of imaging setting values different from an imaging setting value defining the imaging condition at the time point at which the process of said first searcher is executed and an adjusting executor which adjusts the imaging condition of the another part of said plurality of imagers according to the imaging setting value selected by said imaging setting value selector, and said second searcher executes the searching process at every time of selection of said imaging setting value selector.

4. An electronic camera according to claim 1, further comprising a region searcher which searches for a specific region indicating a luminance beyond a predetermined range, from the image outputted from the another part of said plurality of imagers, wherein said first adjuster executes the adjusting process in association with detection of said region searcher.

5. An electronic camera according to claim 4, wherein said region searcher includes a first region extractor which extracts a region indicating a luminance falling below a first threshold value and a second region extractor which extracts a region indicating a luminance exceeding a second threshold value higher than the first threshold value, and said first adjuster includes a high luminance adjuster which adjusts, in association with a process of said first region extractor, an exposure amount of the another part of said plurality of imagers to a high luminance side and a low luminance adjuster which adjusts, in association with a process of said second region extractor, the exposure amount of the another part of said plurality of imagers to a low luminance side.

6. An electronic camera according to claim 1, wherein said the imaging condition adjusted by said second adjuster includes an exposure amount and/or focus setting.

7. An electronic camera according to claim 1, further comprising a recorder which records an image outputted from an imager noticed by said second adjuster.

8. An electronic camera according to claim 1, wherein said recorder records equal to or more than two images respectively outputted from equal to or more than two imagers including the imager noticed by said second adjuster out of said plurality of imagers.

9. An electronic camera according to claim 1, wherein the partial image is equivalent to a face image of a person.

10. An imaging control program recorded on a non-transitory recording medium in order to control an electronic camera provided with a plurality of imagers each of which outputs an image representing a common scene, the program causing a processor of the electronic camera to perform the steps, comprising:
a first searching step of searching for a partial image satisfying a predetermined condition from the image outputted from a part of said plurality of imagers;
a first adjusting step of adjusting an imaging condition of another part of said plurality of imagers to a condition different from an imaging condition at a time point at which a process of said first searching step is executed;
a second searching step of searching for the partial image satisfying the predetermined condition from an image outputted from an imager noticed by said first adjusting step, in association with an adjusting process of said first adjusting step; and
a second adjusting step of adjusts an imaging condition of at least a part of said plurality of imagers by noticing the partial image detected by said first searching step and/or said second searching step.

11. An imaging control method executed by an electronic camera provided with a plurality of imagers each of which outputs an image representing a common scene, comprising:
a first searching step of searching for a partial image satisfying a predetermined condition from the image outputted from the part of said plurality of imagers;
a first adjusting step of adjusting an imaging condition of the another part of said plurality of imagers to a condition different from an imaging condition at a time point at which a process of said first searching step is executed;
a second searching step of searching for the partial image satisfying the predetermined condition from an image outputted from an imager noticed by said first adjusting step, in association with an adjusting process of said first adjusting step; and
a second adjusting step of adjusts an imaging condition of at least a part of said plurality of imagers by noticing the partial image detected by said first searching step and/or said second searching step.
